(19) United States
(12) Patent Application Publication
(10) Pub. No.: US 2019/0392537 A1
(43) Pub. Date: Dec. 26, 2019

(54) Processes for Electronic Administration of Justice Via AI-Gated eMIRANDA Application & Tangible Electronic Devices Generating Self Authenticated Outputs

(71) Applicant: eMiranda LLC, Irvine, CA (US)

(72) Inventors: Andrew G. Ferguson, Washington, DC (US); Richard A. Leo, San Francisco, CA (US); Kaveh Newmen, Irvine, CA (US)

(21) Appl. No.: 16/435,415

(22) Filed: Jun. 7, 2019

Related U.S. Application Data
(60) Provisional application No. 62/689,221, filed on Jun. 24, 2018.
(60) Provisional application No. 62/711,244, filed on Jul. 27, 2018.

(51) Int. Cl. G06Q 50/18; H04M 1/725; G06Q 50/26; G09B 5/12

(52) U.S. Cl. CPC G06Q 50/18; G09B 5/125; G06Q 50/26; H04M 1/72522

(57) ABSTRACT

Artificial Intelligence having legal safety precautions and preventative measures (gates to preclude unmonitored self-learning from altering Justice-diven outcomes) drives electronic media otherwise fully automated, and the like homunculi for the administration of aspects of a unified legal engine for delivery of purely objective justice based solely on Rules of Law, the MIRANDA warnings and concomitant Constitutional Rights being preserved and all of the proceedings recorded and made available to all with discrimination.

### CROSS REFERENCE TO RELATED APPLICATIONS

This application claims the benefit of and priority to U.S. Provisional Patent Application No. 62/689,221; and U.S. Provisional Patent Application No. 62/711,244, both property of a common assignee, the contents of each of which is incorporated herein by reference herein in its entirety. Likewise expressly incorporated by reference as if fully set forth herein, are all U.S. Letters Patent References, which have been listed within this application for U.S. Letters Patent including: U.S. Pat. Nos. 8,905,306; 7,197,167; 7,010,715; 7,007,842; 6,968,999; and 6,669,045, along with all of those references listed below.

### FIELD OF THE INVENTIONS

The present inventions relate to the fields of Artificial Intelligence useful for electronically managing “Justice-based” outcomes within legal systems. In particular, the present inventions rebate to both the software and those portable electronic devices embodying the same which are useful for both interrogators and interrogants to confirm that an understanding that both the Constitutional Rights of those in custody, and the MIRANDA warnings administered to them, have been fairly and properly administered and understood in advance of any waivers of the same.

### BACKGROUND OF THE INVENTIONS

Under the current legal system of the United States of America, custodial interrogation of suspects requires that they be informed of their legal rights to counsel and to refuse to speak to the authority holding them. Owing to reasons explained within the underlying Law Review Article which is likewise incorporated expressly by references, ambiguities within our current systems generates more litigation than most other criminal justice issues, and can be stream lined and made more reliable for all.

### The Miranda App—Scholarly Background.

The Miranda App is the product of decades of scholarly and practical experience studying how the Miranda warnings and waiver process has been implemented. The co-authors, who are co-inventors herein collectively bring significant scholarly and professional experience as scholars, social scientists, practicing lawyers, and legal experts into its design and structure.

The original idea for the Miranda App took the form of a scholarly law review article. The Article was published in the Boston University law Review as part of a Symposium on the Fiftieth Anniversary of the Miranda decision. Before submitting the prototype designs, national legal experts reviewed the content of the prototype and provided feedback to improve it. This appiication details the resultory processes and products thereby which are now being deployed.

As detailed in the Article, the design process sought to address the documented shortcomings of existing Miranda practice and use the digital design to overcome those limitations. Based on scholarship and practical experience, the idea behind the Miranda App was to educate suspects about the Miranda rights and evaluate their levels of comprehension. The goal was to design an App to ensure the knowing, voluntary, and intelligent waiver of constitutional rights through a digital, scripted computer program of videos, text, and comprehension assessments. The Miranda App seeks to provide constitutionally adequate warnings, clarifying answers, contextual information, and age-appropriate instruction to suspects before interrogation. Each of the design choices is based on the research detailed in the law review article. The App is consistent with existing Supreme Court precedent and current police practice, and is designed to use artificial intelligence to update and use data streams to continue to perfect those legal standards, while being gated by an administrative body.

### OBJECTS AND SUMMARY OF THE INVENTIONS

Briefly stated there are provided systems embodying Artificial Intelligence having legal safety precautions and preventative measures (gates to preclude unmonitored self-learning from altering Justice-driven outcomes) which drive electronic media otherwise fully automated, and the like homunculi for the administration of aspects of a unified legal engine for delivery of purely objective justice based solely on Rules of Law, the MIRANDA warnings and concomitant Constitutional Rights being preserved and all of the proceedings recorded and made available to all without discrimination to promote Justice and eliminate much costly litigation.

According to embodiments there is provided a Miranda Application, in summary:

Legal Safety Precautions—A.I. Preventive Measures Preclude Self-Learning preemptions of the system via an Administrator gating the process and data is accumulated.

According to embodiments there is provided Live Audio and Video Recording of entire interaction with application user.

According to embodiments there is provided a Checks and Balances System;
After each page where a question regarding a constitutional right is asked, the application user must verify his understanding of what is being asked of him.
To do this, the user is asked “Do you understand ______” and is prompted to check yes or no.
   If the user checks no, then they will be sent to a second page that will consist of the simplified explanation of the specific constitutional right they are having issue with.
   Further, if we are to assume that the user continues having issues understanding his right, this will be audio and video recorded for a third party to review and the user will be prompted to exit out of the application and handing the device the app is on back to the officer/detective/probation officer.

According to embodiments there is provided a User Login, Department Specific login that will be traceable to the police officer using the device the application is on.

According to embodiments there is provided an Audio and video recording begins at onset and will continue until the user exits out of the application.

According to embodiments there is provided Interview Details, basic information that could be found on drivers license.

According to embodiments there is provided User will be prompted to select native language for the application to be carried out in.

According to embodiments there is provided a Disclaimer educating app user on what rights he has and what the miranda process is.

According to embodiments there is provided where the miranda process begins and the user will be prompted to check yes or no on his rights.

According to embodiments there is provided that a user will be provided with cartoon like descriptions, the ability to read the words on the screen, and if needed for people suffering with hearing problems have the words read aloud.

According to embodiments there is provided further protections such that if a user has any issues with any of the words (such as not understanding the word or sentence as a whole) they may click on any word that they have issue with and it will then take them to wireframe 6, where the word they clicked on will be highlighted with the definition provided. Further, if they wanted they can spend more time on wireframe 6 getting a better understanding of the entire right as a whole, for example, “You have the right to remain silent” followed by the definitions provided in the Miranda App Summary.

According to embodiments there is provided a definitions page where if anyone has any issues with a specific right or word, they may learn more about it to further develop a better understanding of their constitutional rights

According to embodiments there is provided, for example, on wireframe 5 and 6 the user will have the ability to say that they do not understand their rights (by clicking on a link) and would rather have a human take over.

According to embodiments there is provided that once the user has completed the Miranda app process, he/she will be asked one final time if they have a full understanding of their rights and if it was done in a non coercive environment. This will require them clicking on a box without the aid of the police officer.

According to embodiments there is provided a face ID system that will be unique to the individual officer accounts. This in theory would allow us to know when the officers face is on the screen (which would mean he is in close enough proximity to possibiy influence the user to selecting an answer he otherwise wouldn't have) and allow the app to issue a warning screen or some similar protective measure until the application is clear and only being used by the suspect who is being mirandized.

According to embodiments there is provided the final report of the Miranda readings will be sent back to the cloud with a copy of the audio/video mp3 file available for the courts (DA/PD, Attorney, Judge, Police, Etc.) to review it to determine whether or not the suspect was coerced during his Mirandizing.

Accoroing to embodiments there is provided A system, further comprising a digital process to verify a user's understanding of a series questions comprising, in combination: MIRANDA rights and the implications of all warnings derived from the same, along with the user's rights under the Constitution of the United States of America in terms of rights to refuse to answer questions, which is able to be understood and interacted with by the user, while in custody, and is recorded live in both audio and video versions having electronic fail-safes to preclude alteration thereof.

According to embodiments there is provided a system, further comprising at least a digital process to veriiy a user's understanding of a series questions comprising, in combination: MIRANDA rights and the implications of all warnings derived from the same, along with the user's rights under the Constitution of the United States of America in terms of rights to refuse to answer questions, which is able to be understood and interacted with by the user, while in custody, and is recorded live in both audio and video versions having electronic fail-safes to preclude alteration thereof, along with Artificial Intelligence human mediated gates to preclude unmonitored self-learning from altering Justice-driven outcomes.

### BRIEF DESCRIPTION OF THE DRAWINGS

Various preferred embodiments are described herein with references to the drawings in which merely illustrative views are offered for consideration, whereby:

FIG. 1 shows a flowchart depicting a species of the genus of the present invention as shown and described;

FIG. 2 shows a flowchart depicting a species of the genus of the present invention as shown and described;

FIG. 3 shows a flowchart depicting a species of the genus of the present invention as shown and described;

FIG. 4 shows a flowchart depicting a species of the genus of the present invention whereby the AI has a soft gate as a legal safety precaution to provide checks and balances and ongoing administration of justice which precludes tampering with or otherwise corrupting of the system, as shown and described;

FIG. 5 shows a flowchart depicting a species of the genus of the present invention as shown and described whereby the AI has a hard gate as a legal safety precaution to provide checks and balances and ongoing administration of justice which precludes tampering with or otherwise corrupting of the system, as shown and described;

FIG. 6 shows a “screen shot” or wireframe depiction of the instant MIRANDA APP, as embodied in a conventional smart tablet device being linked to the Internet & Cloud(s), as described and claimed herein having a prompt for a user to “click” advancing the screen;

FIG. 7 shows a “screen shot” or wireframe depiction of the instant MiRANDA APP, as embodied in a conventional smart tablet device being linked to the Internet & Cloud(s), as described and claimed herein having a prompt for a user to “click” advancing the screen, or one to return to prior screens for more information;

FIG. 8 shows a “screen shot” or wireframe depiction of the instant MIRANDA APP, as embodied in a conventional smart tablet device being linked to the Internet & Cloud(s), as described and claimed herein;

FIG. 9A shows a “screen shot” or wireframe depiction of the instant MiRANDA APP, as embodied in a conventional smart tablet device being linked to the Internet & Cloud(s), as described and claimed herein;

FIG. 9B shows a “screen shot” or wireframe depiction of the instant MIRANDA APP, as embodied in a conventional smart tablet devce being linked to the Internet & Cloud(s), as described and claimed herein;

FIG. 10 shows a “screen shot” or wireframe depiction of the instant MIRANDA APP, as embodied in a conventional smart tablet device being linked to the Internet & Cloud(s), as described and claimed herein;

FIG. 11 shows a “screen shot” or wireframe depiction of the instant MIRANDA APP, as embodied in a conventional smart tablet device being linked to the Internet & Cloud(s), as described and claimed herein;

FIG. 12 shows a “screen shot” or wireframe depiction of the instant MIRANDA APP, as embodied in a conventional smart tablet device being linked to the Internet & Cloud(s), as described and claimed herein;

FIG. 13 shows a “screen shot” or wireframe depiction of the instant MIRANDA APP, as embodied in a conventional smart tablet device being linked to the Internet & Cloud(s), as described and claimed herein;

FIG. 14 shows a “screen shot” or wireframe depiction of the instant MIRANDA APP, as embodied in a conventional smart tablet device being linked to the Internet & Cloud(s), as described and claimed herein;

FIG. 15 shows a “screen shot” or wireframe depiction of the instant MIRANDA APP, as embodied in a conventional smart tablet device being linked to the Internet & Cloud(s), as described and claimed herein;

FIG. 15 shows a “screen shot” or wireframe depiction of the instant MIRANDA APP, as embodied in a conventional smart tablet device being linked to the Internet & Cloud(s), as described and claimed herein;

FIG. 17 shows a “screen shot” or wireframe depiction of the instant MIRANDA APR, as embodied in a conventional smart tablet device being linked to the Internet & Cloud(s), as described and claimed herein;

FIG. 18 shows a “screen shot” or wireframe depiction of the instant MIRANDA APP, as embodied in a conventional smart tablet device being linked to the Internet & Cloud(s), as described and claimed herein;

FIG. 19 shows a “screen shot” or wireframe depiction of the instant MIRANDA APP, as embodied in a conventional smart tablet device being linked to the Internet & Cloud(s), as described and claimed herein;

FIG. 20 shows a “screen shot” or wireframe depiction of the instant MIRANDA APP, as embodied in a conventional smart tablet device being linked to the Internet & Cloud(s), as described and claimed herein;

FIG. 21 shows a “screen shot” or wireframe depiction of the instant MIRANDA APP, as embodied in a conventional smart tabiet device being linked to the Internet & Cloud(s), as described and claimed herein;

FIG. 22 shows a “screen shot” or wireframe depiction of the instant MIRANDA APP, as embodied in a conventional smart tablet device being linked to the Internet & Cloud(s), as described and claimed herein;

FIG. 23 shows a “screen shot” or wireframe depiction of the instant MIRANDA APP, as embodied in a conventional smart tablet device being linked to the Internet & Cloud(s), as described and claimed herein;

FIG. 24 shows a “screen shot” or wireframe depiction of the instant MIRANDA APP, as embodied in a conventional smart tablet device being linked to the Internet & Cloud(s), as described and claimed herein;

FIG. 25 shows a “screen shot” or wireframe depiction of the instant MIRANDA APP, as embodied in a conventional smart tablet device being linked to the Internet & Cloud(s), as described and claimed herein.

Corresponding reference characters indicate corresponding components throughout the several views of the drawings. Skilled artisans will appreciate that elements in the figures are illustrated for simplicity and clarity, and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTIONS

It is respectrully proposed that the present inventors have designed a software platform, specialized hardware, interfaces and communication enhancers and modifiers to implement, using Artificial Intelligence (AI), an app for Miranda warnings (“MIRANDAPP” or The Miranda App or MIRANDA APP), likewise embodied in portable electronic devices, and related general and special purpose computing devices for use in the field.

Expressly incorporated by reference as if fully set forth herein are the following: U.S. Patent and Publication Numbers: U.S. Pat. Nos. 10,241,887; 9,906,444; 9,948,528; 9,882,798; 9,841,865; 9,547,710; 9,466,031; 9,298,538; 9,245,000; 9,132,909; 9,058,259; 8,905,306; 8,751,867; 8,201,738; 8,060,342; 7,869,967; 7,801,703; 7,707,285; 7,620,523; 7,467,067; 2007/00406900; 2011/0196518; 2015/0046349; 2016/0078579; 2018/0075555; and 6,188,939.

The Mirondo App as designed is effective for working on any general or special purpose computer, tablet, iPad, or/and smartphone or specialized disposable versions of the same, virtually any fungible tool works for the purpose of the instant application. The Miranda App is launched with a click of a button, and there is no other mediation between the user and the digital interface outside of human created AI connections, and the soft and hard gating events as explained below. The data stream remains part of the system, and the software self-aggregates or becomes part of a great super-set of data from which determinations are made and stored for the next usage.

All information in, on, or within the device and uploaded into secure servers, and/or as web-app, hosted onto a dedicated URL and accessible to anyone with online connectivity and password access. A video feed records the suspect as she interacts with the App. As a result, the device captures a biometrically complete video of the suspect's face as she works through the App. In addition, the device collect audio of the suspect's interaction with the Miranda App.

### Definitions

Artificial Intelligence or simulation of select human-like mental processes by computer systems including, within the context of the instant app, learning (acquisition of information and rules for the information), reasoning (using the accumulated rules to reach conclusions within the system) and self-correction along with speech and identify recognition and storage, are mediated by human interaction via “Gating” or passing through human intervention by design at a system level.

Questioning—To ask questions of someone.

Criminal prosecution—A criminal case begins when the police investigate and/or a government official called a prosecutor of district attorney charges a person suspected of a crime with an offense.

Speak with police—Talking to police officers, including answering any questions.

Miranda rights—The right to silence during custodial police interrogation, the right to an attorney during custodial police questioning; the right to have an attorney paid for by the government if a person cannot afford an attorney; and the right to be notified that anything one says during police questioning can be used in a criminal trial.

MIRANDAPP or The Miranda App or MIRANDA APP means the underlying application or software structure as configured to implement the instant system as defined and claimed herein, including such special purpose computing devices into which the same is emplaced.

Miranda warnings/Miranda related information that which on the objects of the present invention is presented in formats for both visual and auditory learners comprising warnings that the police give to a suspect in custody prior to police questioning. These warnings advise suspects of the right to silence during custodial police interrogation; the right to an attorney during custodial police questioning; the right to have that attorney paid for by the government if the suspect cannot afford an attorney, and the right to be notified that anything one says during police questioning can be used against that person in a criminal trial.

Choice to speak—Choosing or making the decision to answer questions or to talk to another person.

Gates, Soft & Hard—Computer elements where an Administrator acts within the stream of the process connecting (soft) or potentially interrupting (hard) data stream flow otherwise mediated by artificial intelligence. User's trigger each gate by their response.

Statements—Giving police information.

Prosecutors—A public official who institutes criminal proceedings against someone.

Decide to prosecute—The decision to file criminal charges against someone.

Right—A thing that legally entitles an individual to do something or to avoid doing something, in this instance derived from the U.S. Constitution s interpreted by the United States Supreme Court.

Criminal justice process—The pre-trial and trial process used in a criminal case to decide whether an individual charged with a crime should be found guilty of committing it.

Criminal trial—A trial in which a jury of your peers or a judge decides whether an individual Is guilty of committing a crime.

Justice-based—Within this application, this means that artificial intelligence has been applied to match legal precedent with factual data harvested by the App and applied to the case at hand to generate a result which can be corroborated and thus self-authenticated at a dignity level admissible in Court.

Second, all of the Miranda related information is presented in formats for both visual and auditory learners, and designed consistent with established Web Content Accessibility Guidelines. Some suspects may not be able to read, but can comprehend verbal instructions. Other suspects may only learn by seeing and studying the words themselves. In addition, because the medium of an App allows for digital innovation, we envision video, graphics and animations adding explanatory power to the design. Written descriptions of legal terms couid be accompanied by visual explanations through images, graphics, animations, or hyperlinks. Videos of real people, avatars, or a combination of the two could be used to capture the attention of viewers. A narrator (available in multiple languages) would guide users through the process of understanding Miranda warnings and obtaining a valid waiver or acknowledging the invocation of rights. See Infra BULR 97:935-951.

As driven and modulated by AI, all descriptions and lessons must be communicated in a slow, clear and repetitive manner. Because electronically mediated instructions can be intimidating to some, and too much information to process for others, a mechanism for review and repetition must be built into the process. A playback mechanism akin to a digital video recording device will allow the suspect to rewind and replay the tape. Design choices must be made to remedy the limited educational backgrounds and legal experience of some suspects. Layout and information should be simple, spare, basic, and clear. Systems to double check comprehension, mechanisms to portray the same information in different formats, and literal repetition will enhance learning.

Other design choices are culturally sensitive so that suspects will not be insulted or distanced from the relevance to their lives. One could even offer individuals a choice of programs that might be more culturally relevant to their particular circumstance.

Finally, the Miranda App must reinforce the gravity of the information provided. The way the App conveys the information must reflect the significance of the constitutional lessons being imparted, and the tone of the App must match the seriousness of the constitutional moment. The App should be viewed not as a game, but more like a test. It is noted that “gamification”, such as defined in U.S. Pat. No. 10,016,683 would be an exception here, where AR/VR overlay may be used to play “test-like” actions like a game.

Miranda requires a suspect be informed of particular rights relevant for the particular experience of custodial interrogation. The MIRANDAPP thus emphasized the important of accurately establishing the context of what is happening to the suspect now, and what is going to happen to the suspect in the future.

In a traditional interrogation, a detective offers some prologue before giving the Miranda warnings. This police-directed prologue is replaced by handing over an electronic device with the Miranda App. As such, the Miranda App must orient the suspect to why they have been handed this electronic device and what is going to happen next.

It is likewise posited that the MIRANDAPP must explain key constitutional rights in the context or the adversarial process. By removing the detective from the recitation of the warnings, a symbol of adversarial conflict is also removed. Yet the adversarial posture remains. The Miranda App must still explain the adversarial reality of the interrogation process. The App must convey what will occur, without the suspect necessarily being in the interrogation room or facing an interrogating detective. Establishing the adversarial context is, thus, an important part of the introduction.

Such orientation may also include explaining how interrogation fits within the larger criminal justice system. Most suspects fail to see how what they say in a police station might impact all of the other players and moments later on in the criminal justice system.

So the first step is to provide appropriate context to the suspect about (1) why they have been handed the Miranda App, and (2) how this Miranda App process fits within the larger criminal justice system. See Infra BULR 97:935-951.

By way of examples, an initial introduction must explain that the following process is designed to inform you of your constitutional rights, and offer a moment to understand the choice to speak with police or not. The introduction can explain that the Miranda warnings process comes from the United States Supreme Court (the highest court in the land), finds its roots in the United States Constitution (Fifth Amendment) and is an established police practice recognized across the land. One can imagine visuals of the Supreme Court, the Constitution, and police reciting Miranda rights, on VR/AR or smart AI driven animations describing where these other abstract rights come from in some visual form.

The introduction should explain that it is axiomatic that with the MIRANDAPP this digital process replaces a police detective reciting the Miranda warnings. This is necessary, as some suspects might be familiar with traditional police practice from television, the movies or past experience with police.

The introduction should reaffirm the seriousness of what constitutional rights are and why a considered decision should be made before claiming them or waiving them.

The introduction should include a statement explaining that a police interrogation is just the initial step in a larger adversarial process, and then provide a limited contextual understanding of the criminal justice process, from interrogation to trial. This brief overview should explain the roles of the various players in the criminal justice system.

All of these principles will be repeated throughout the process, but it is important to provide an initial introductory overview of what is happening before detailing the specific Miranda warnings or waiver questions.

Miranda warnings both counteract that custodial pressure on well as educate suspects about the available constitutional rights.

The universal nature of the approach and its implementation [MIRANDAPP] does directly explain the dangers of custodial environments and the role of constitutional rights. To be clear, this step is analytically distinct from the question of “why have you been handed an iPad?” instead informing suspects of the substantive purpose of the information they are going to be provided.

So, the working assumption that constitutional understanding will counterbalance police coercion should be explained to the suspect. Again, a simple declaration that the reason Miranda rights are being provided is to level an inherently coercive playing field might be sufficient to provide the “why” of why Miranda exists.

While critical, this part need not be long or involved. The only thing necessary to articulate is the usually unarticulated underlying assumption of why the Supreme Court thought Miranda was necessary. Two points must be included: (1) the reality of custodial pressure, and (2) how being informed of one's constitutional rights serves to counteract custodial pressure.

The formal Miranda warnings are provided, literally, namely, the actual Miranda warnings as envisioned by the Supreme Court and recrafted by law enforcement professionals. As the Supreme Court has made clear in Florida v. Powell and earlier cases, the Miranda warnings do not require particular magic words to be constitutionally sufficient. As a constitutional requirement, substance counts over form, and police departments retain flexibility in how to convey those warnings. The App does however take seriously the importance of suspects' understanding those rights, and thus incorporates an overt education-focused approach to explaining Mironda rights. See Infra BULR 97:935-955.

According to this example, AI governs this species by administering at least a three-fold change to existing practice, allowing: (1) better comprehension of the words that convey constitutional rights, (2) clarify about the meaning of constitutional rights; and (3) a space for deliberative reflection about the decision at hand. By design, according to the present invention, we offer a more intentional educational approach that specifically addresses some of the weaknesses in current Miranda practice.

Language of Miranda warnings is required, namely, the right to remain silent, the knowledge that anything you say can be used against you in a court of law, the right to talk to a lawyer for advice before questioning, the right to talk to a lawyer during questioning, the right to have a lawyer appointed for you without cost, and the ongoing nature of these rights.

Language facilitates understanding. If suspects do not understand the words within the Miranda warnings, then they likely cannot understand the meaning of the warnings. See Infra BULR 97:935-957.

The MIRANDAPP does directly explain the dangers of custodial environments and the role of constitutional rights. To be clear, this step is analytically distinct from the question of “why have you been handled an iPad?” instead informing suspects of the substantive purpose of the information they are going to be provided.

The “government,” after all, also pays the salaries of the police, prosecutors, and the judges, so why would this appointed lawyer be on the suspect's side? Without an explanation of how the government divides responsibilities, why it creates an adversarial system, and who enforces the duties of defenders, the mere “appointment” of a lawyer does little to answer the ultimate question of what that “appointment” actually means.

According to the present invention, which explained the adversarial system, and the role oi the defense lawyer, would then address these concerns arising from the offer of free legal assistance. This explanation need not be lengthy, but should directly address the concerns with logistics and legal duty.

Miranda protections continue throughout the interrogation. If at any moment the suspect wishes to invoke his rights to silence or counsel, he can do so, even after originally waiving those rights. This reality is embedded In the phrase used to convey the on-going nature of those rights, e.g., “You can decide at any time to exercise these rights and not answer any questions or make any statements.” This statement is both comforting and counterintuitive. A suspect can “consider the choices he or she faces” and “reassess his or her immediate and long term interest” during a lengthy interrogation process.

Further, for those suspects who might not understand how or why they can change their minds about speaking with police. Post waiver, once the conversation has begun; the ability to choose again may not seem possible. The continued coercive environment, the human pressure, and the lack of understanding of how to reclaim those previously waived rights all increase confusion, and is key as, the ongoing nature of the rights by clarifying that the initial waiver can be reconsidered. See Infra BULR 97:935-981.

Improving the language and explanations of the rights behind the Miranda warnings obviously might improve comprehension. But to buiid upon this, the present invention offers one other, less obvious, benefit: distance to reflect on one's decision.

The present invention creates a space for some thought because it takes place independent of police controlled questions. By giving suspects a moment to think and inquire about rights, a natural space will develop to consider the decision. While digital media does not necessarily encourage deep reflection, and many people are familiar with simply skipping past all of the fine print of any computer mediated waiver form, according to the misguided hope will be that some time and space will be created to think about that decision to waive or not. See Infra BULR 97:935-988.

According to the present invention AI drives that the waiver or invocation of constitutional rights as binary choice, but as any student knows, the gray areas of implicit waiver, ambiguous invocation, and miscommunication between officers and suspects has made the process quite uncertain prior to the instant teachings.

Using AI drivers it is now possible to improve instructions for both waiver and invocation. Likewise inherently, it can also memorialize the intent of the suspect with a clarify lacking in a human system. The present invention will force suspects to make a choice—waive or invoke—and do so in a manner that will be unambiguous. Probably to the relief of most courts, debates over ambiguous invocations should end.

Waiver and invocation applied, means that the present inventions approach to waiver and invocation tracks the traditional practice with one big change it explains in a transparent manner the consequences of each choice and then forces the suspect to make a choice. See Infra BULR 97:935-991.

According to one example there is a decision tree for suspects. For suspects who wish to waive their rights, the App explains the meaning of waiver and the possible benefits of talking with police. For suspects who wish to invoke, the App explains the consequences of invoking, and further explains that such a choice will constitute “an unambiguous invocation” or Miranda rights. Because the computer will guide the choices into a binary framework, there will be no option for an ambiguous assertion. Because there will be either a waiver or invocation, there will be no cause to debate implicit waivers. The decision tree design and binary choice of the system removes much of the human miscommunication. It also provides clear proof of the choice. By using AI, the present invention will make the choice, answers, and decision clear before the suspect speaks with the detective.

Finally, the present invention provides explicit instructions of the “magic phrases” to invoke Mironda after an interrogation has begun. The suspect will be informed that to invoke the right to silence she must state, I would like a lawyer.” While variations of these phrases might be acceptable. See Infra BULR 97:935-989.

The Miranda waiver process only works if the suspect understands the warnings and chooses to speak with officers. The difficulty has always been how to access the level of comprehension of the suspect. By providing more information about the Mironda process, can offer clues as to how every suspect interacts with the software. In addition, a designer could incorporate actual assessment tests to ensure adequate comprehension.

In thousands of individual criminal cases, Mironao competence has been litigated. Experts routinely testify about levels of comprehension and some of the problems facing individuals in making an informed judgment.

App can be designed to flag issues of comprehension and understanding for these groups. Assessment measures can be built within the software to identify the common struggles from certain groups, which, in turn, will allow for a better understanding of how certain people understand (or fail to understand) Miranda.

Removing the human interface of interrogation does not eliminate custodial pressure. The Miranda Court also focused on how an environment, of isolation and ignorance combine to pressure suspects. Simply put, being alone and without contact with the outside world, or ignorant of the legal or procedural process, undermines a suspect's ability to resist the police-dominated environment.

The computer program—not the police—will describe the legal choices available. While the coercive environment will not be eliminated, the pressure might be ameliorated.

Using AI shifts the course of constitutional power away from the police. Miranda rights would no longer be “granted” by police. One of the inherent limitations of traditional Miranda warnings is that they are provided by police officers who seemingly control the constitutional protections. In 1965, the fifth Amendment's protections existed outside police control, and were designed to counteract police power. But, because the information is mediated through police officials, the source of that power gets muddied in practice.

The present invention, witn AI data, helps empower citizens by reminding (or teaching) them that their constitutional rights exist independent of and, fundamentally in opposition to, the government.

The present invention use AI for providing both a factual and contextual understanding. In order to ensure a real understanding of Miranda warnings and waiver at a far more sophisticated level than current practice. If utilized, would provide a strong argument against a defense challenge that the suspect did not understand his or her Miranda rights, and the present invention will educate suspects with a clear, complete, and constitutionally approved explanation of Fifth Amendment rights. The language of the videos and warnings will be informed by Supreme Court cases and thus should survive constitutional challenge.

According to embodiments, police will hand over the computer to the suspect. The suspect will follow the prompts and complete the process. All the information will be recorded. The police officers will not have to do anything else during the interrogation. But, perhaps even more enticingly, police will avoid future litigation about waiver or invocation.

The plug-and-play nature of the App will allow police to simply start the App with the information collected without any further manual effort. For many routine arrests, this process will simplify booking, paperwork, and evidence collection. The technology will also streamline post-confession litigation as the trial courts will be presented with a transparent record of the warnings and decisions of the suspect. Lengthy pretrial hearings about Miranda will be short-circuited by a clear and well-established record of waiver or invocation.

One of the innovations behind the instant AI driven invention is software is the ability to track progress at a granular level. Every click or query can be evaluated. The time taken on different sections can be analyzed. For example, if a particular term of art in the Miranda script regularly confuses users, then that information can be captured and studied if a particular question always requires more information or an inordinate amount of time to complete, that section could be flagged for more clarification. Currently, we do not know in any systemic way how suspects understand Miranda. Once widely accepted, the Miranda App can provide a national sample of how suspects understand Miranda and the legal terminology that underlies Miranda. Each Miranda moment will be cataloged, saved, and archived for study at some later time. This “data” drives the self-learning AI modulated nature of the process and is in essence “owned” by the MIRANDAPP and said data hypothetically only at discretion of Adminstrator.

In creating this database of Miranda reports and raw information, AI protects privacy and allocates data preservation and storage to protect rights of all by design.

Technological literacy means the present invention is available to all suspects. As criminal suspects range in age from teenagers to senior citizens and from the highly educated to the barely educated, the level of technological literacy wili vary accordingly. Some suspects may not feel comfortable learning through a computer screen and may lack the basic computer skills to scroll through a self-administered timed or otherwise modulated subroutine.

On the opposite side of the technological spectrum, some sophisticated digital users may be so accustomed to digital prompts and virtual agreements that they ignore the serious nature of the process.

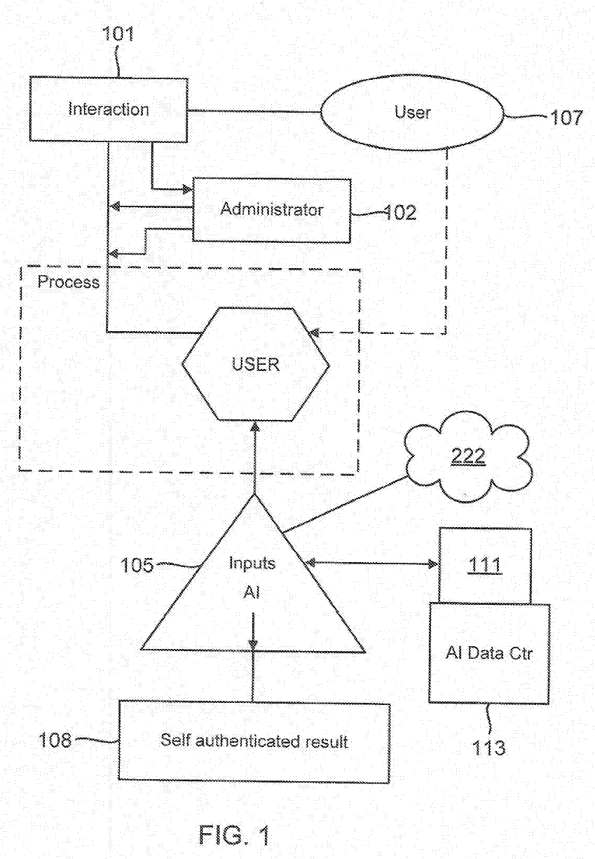

FIG. 1 shows a flowchart/process diagram schematically depicting how User 107, following interaction 101, for example, allegedly offending the law and being arrested for the same, Administrator 102 then uses the process to administer, to user, the MIRANDA warnings 103, whereby fifth Amendment rights must be understood and acknowledged, and/or waived by USER, however the process is governed by AI logic 105 and not human intervention of subjective inputs, said resuitory Output 108 being self-authentication eligible as evidence in Federal District Court or in the process of being so Certified. A1 Data Center 113 and 111, defining input & output links AI Data Cloud sets 222 with the governing function of the instant systems as known to artisans.

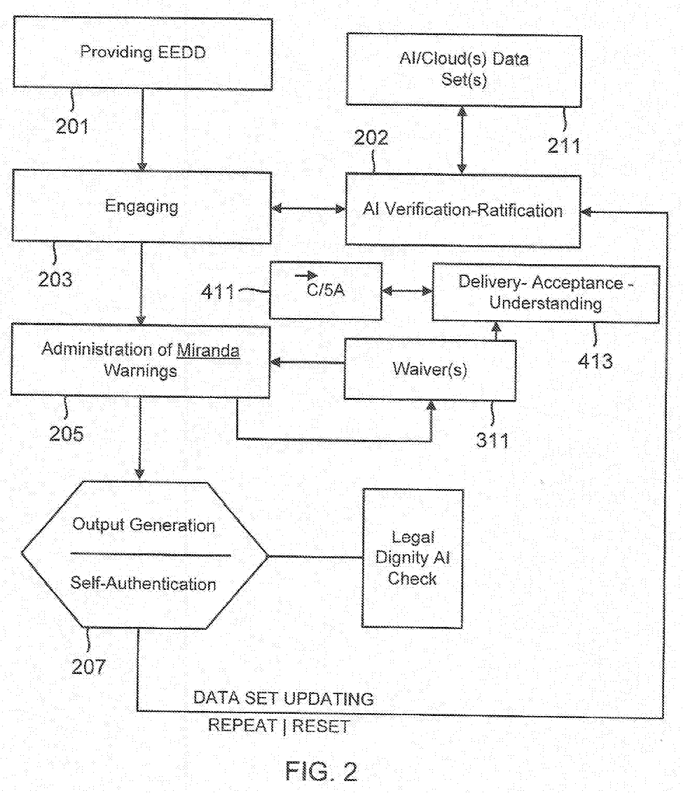

FIG. 2 likewise shows A process for administering MIRANDA warnings, which comprises the steps of, providing an electronically enabled digital (EEDD) device 201 for delivering data to a user or participant, engaging said EEDD with the user or participant 203 in a topic neutral gender aschematic fashion whereby data only which is verified and ratified by AI Engine-means 202. 411 is one set of said indicia namely for MIRANDA WARNINGS purposes Verification of identity—status—legal state—communication needs in terms of the Constitution of the United States and the Fifth Amendment, 413 in said data.

Administration 205 and output generation likewise follow-suit. Waivers 311 and the interplay of the data sets as shown is known to artisans. AI homunculi, similar are established for each of said functions from Administration of MIRANDA warnings 205, to 413 AI verification—ratification of delivery—acceptance—understanding, as discussed infra. Likewise, enabling OUTPUT GENERATION 207; and Data Set updating and repeating are embraced.

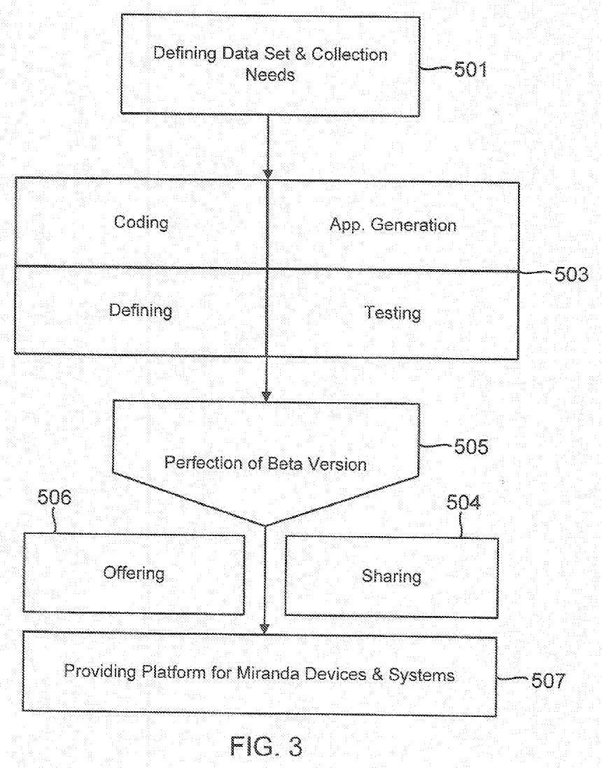

FIG. 3 shows a process for designing the AI driven systems of the present inventions at detailed levels of abstraction for using digital means for improving administration of criminal justice goals, needs is proposed—the present inventor has combined artificial intelligence/AI with a longstanding need to generate an application for computing devices embodying same. Perfecting Data set 501 & detailing future data collection needs was followed by employment of technology drivers 503, namely coding defining app generation and testing followed by BETA version perfection 505 and offering 506 and sharing 504 with peers before providing said platform 207.

The terms “wireform” and “screenshot” are interchangeable functionally herein, and are so used.

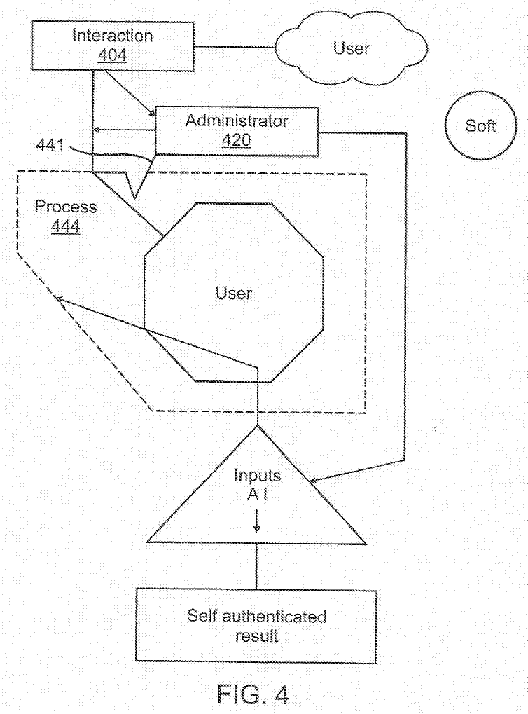

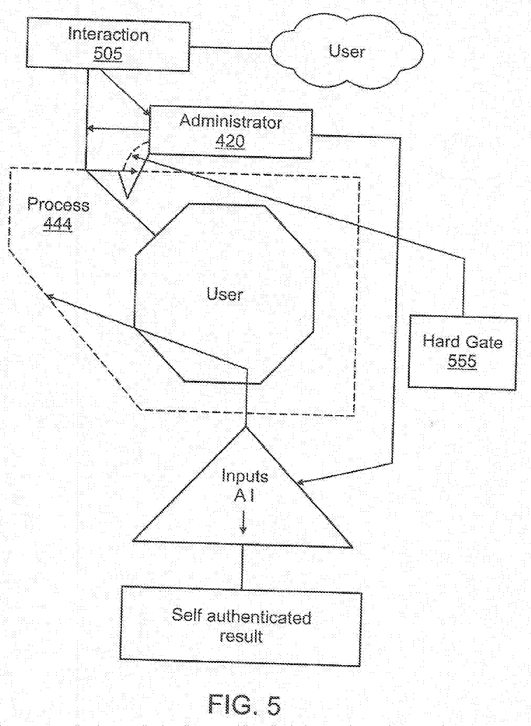

Referring now to FIG. 4 and to FIG. 5, a schematic illustration of the soft v. hard gating is illustrated as embodied with the instant inventions. Interaction 404 yields in a soft gate through Administrator 420, meaning overview and review of process 444 at joining or soft gate 447. This occurs when, for example a Constitutional right is being explained and a user must verify understanding of the same, or when words needs to be verified, or any context is needed to enhance the user's ability to be knowingly and intelligently participating in the process.

FIG. 5 demonstrates hard gating at 555 where Administrator 420 takes over because the AI system is opted out of and User. User opts out of process 444, such as requesting human takeover, as detailed in the figures and text and claimed below.

The present inventors have attempted to overcome many of the serious biases inherent in the process of administration of warnings under the MIRANDA standard dictated by the United States Supreme Court. In undertaking this exercise, they have solved unexpected problems and streamlined numerous issues, which shall eliminate many hours of litigation.

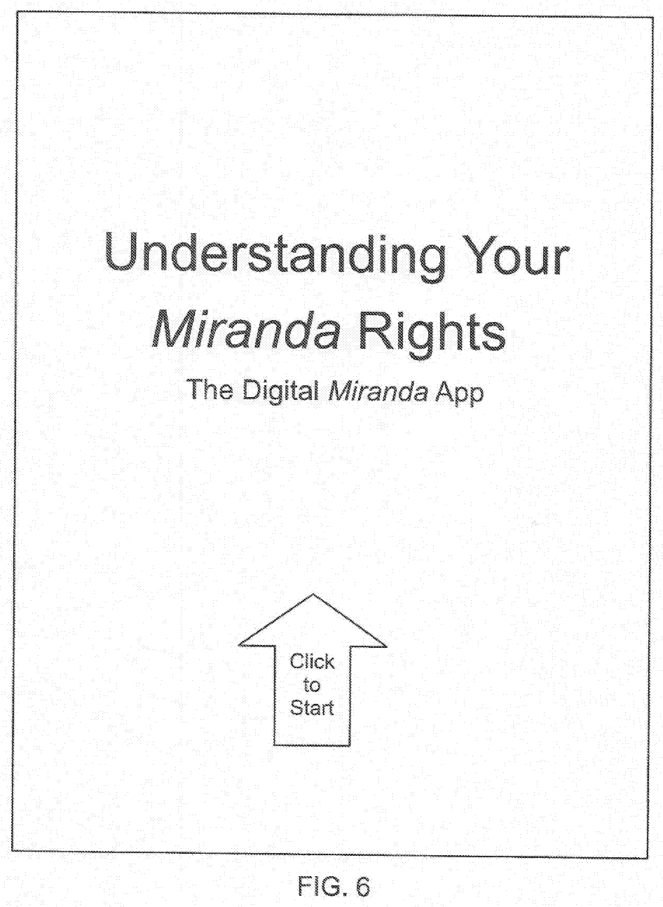

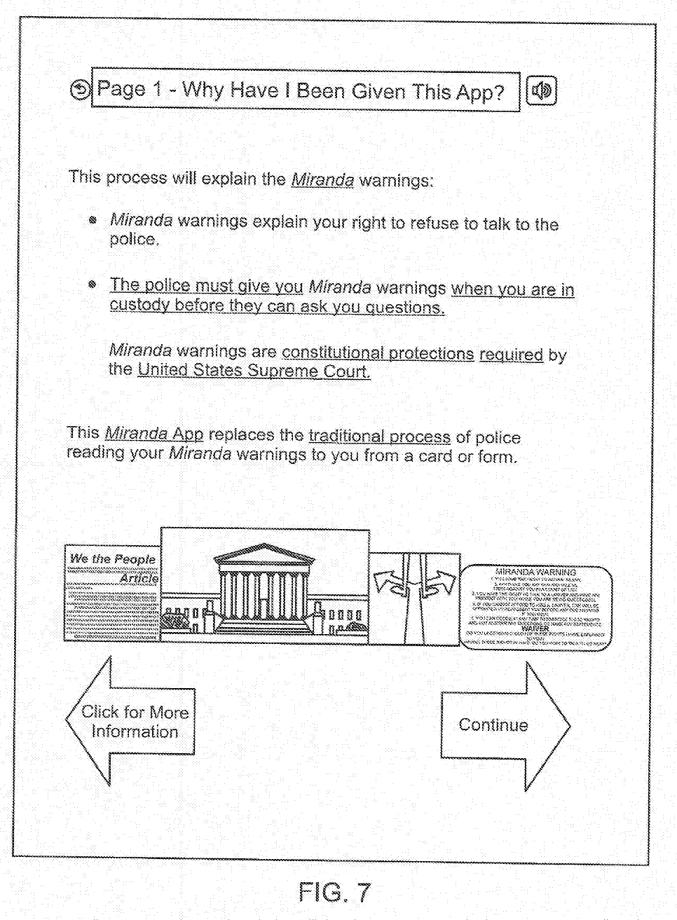

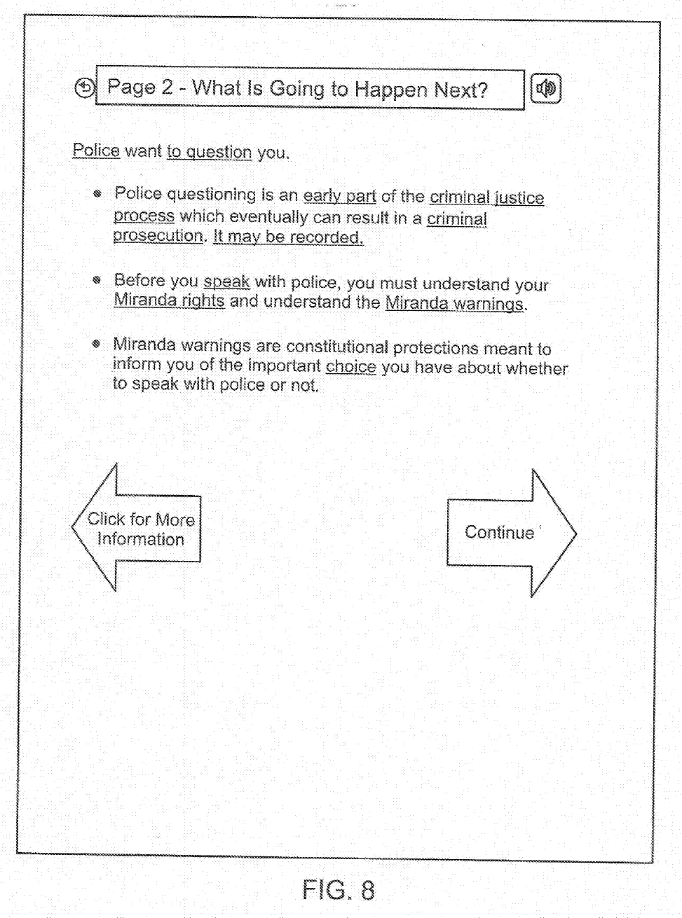

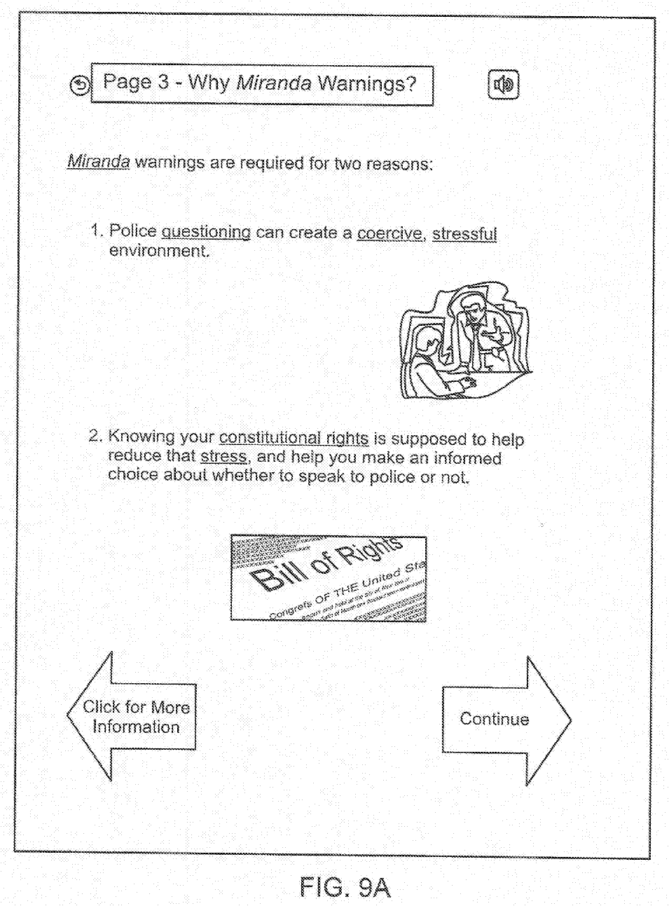

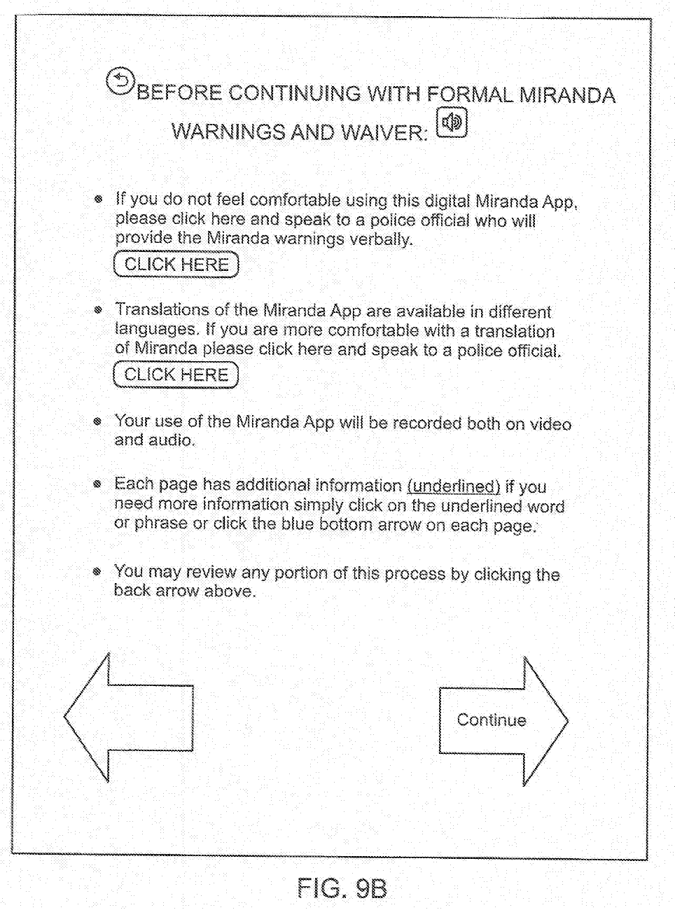

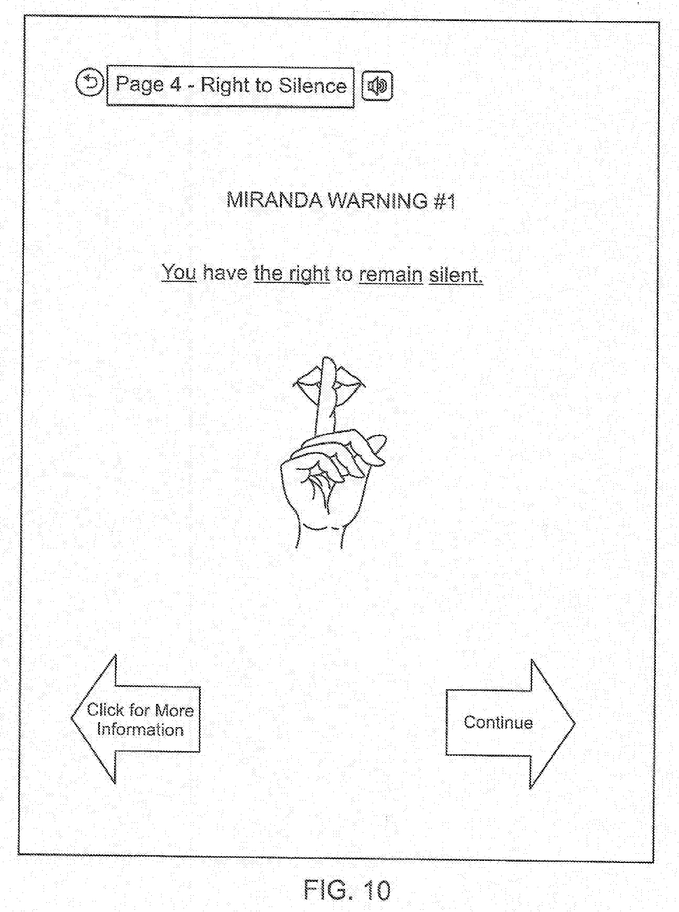

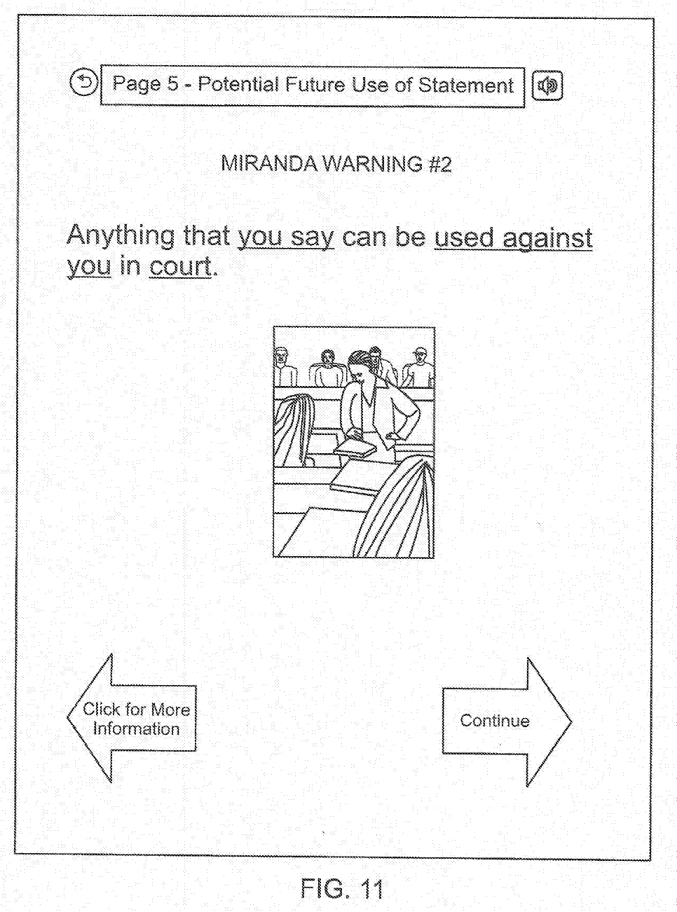

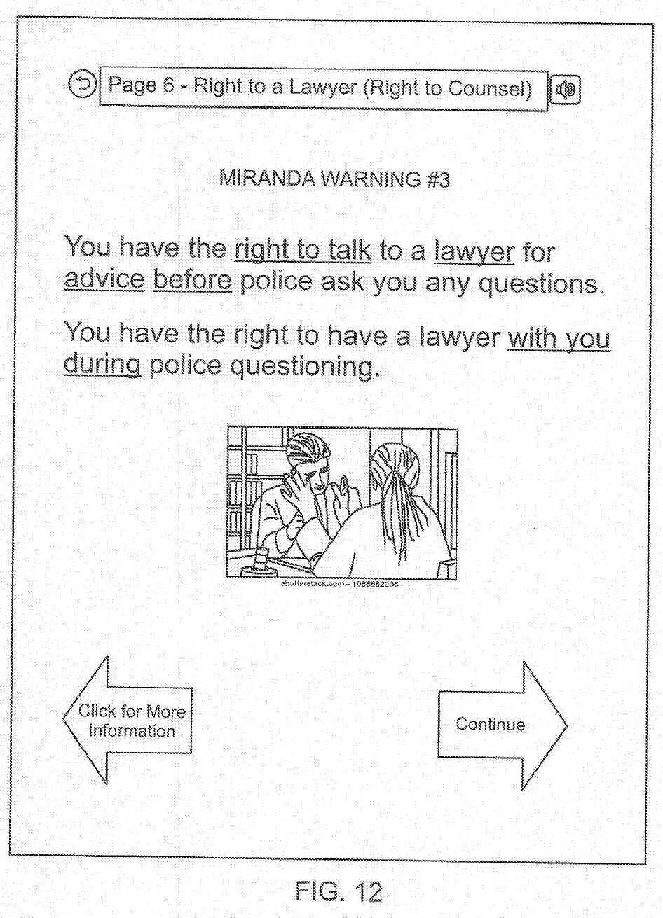

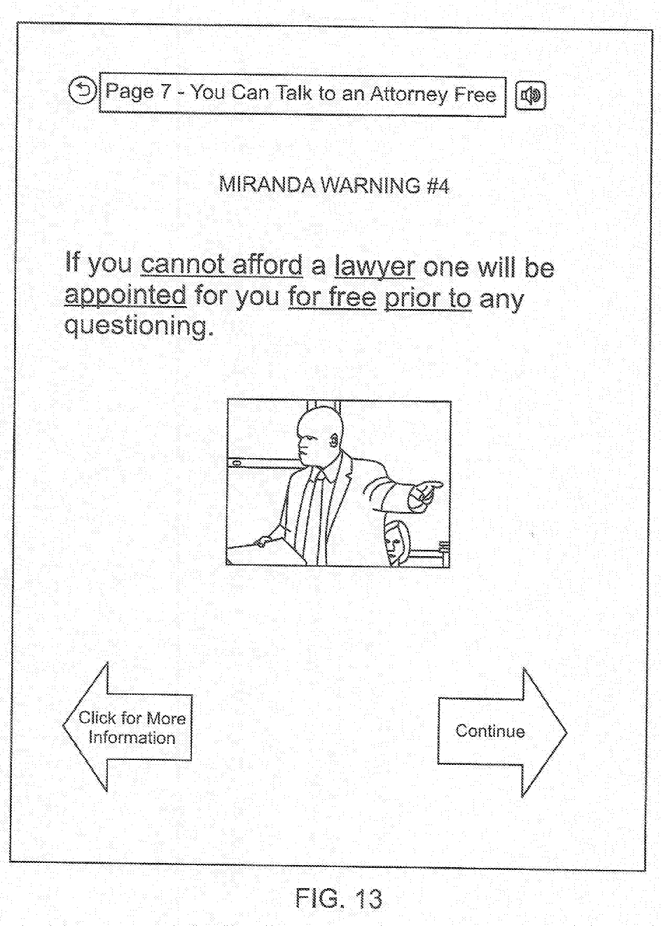

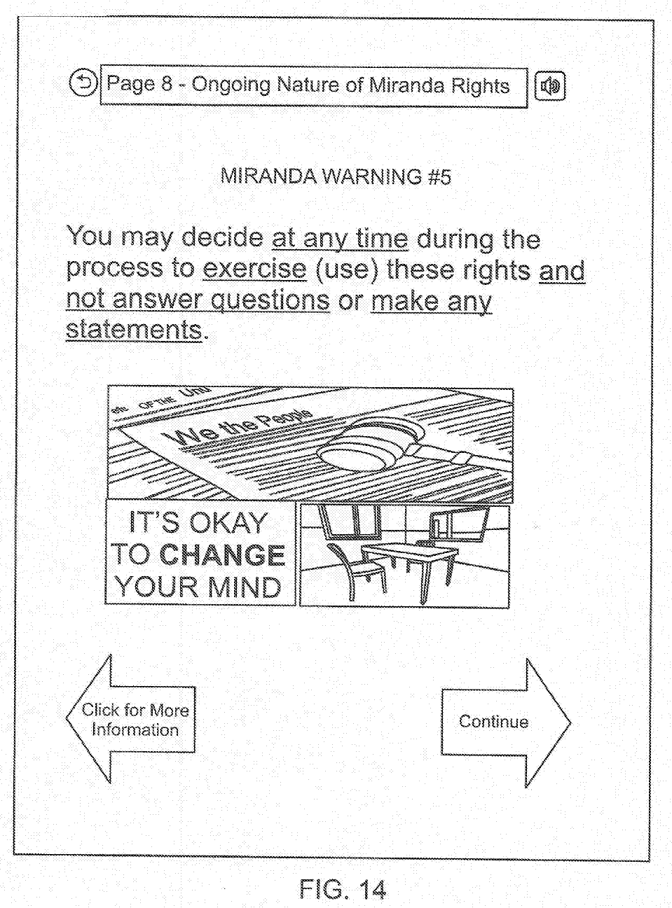

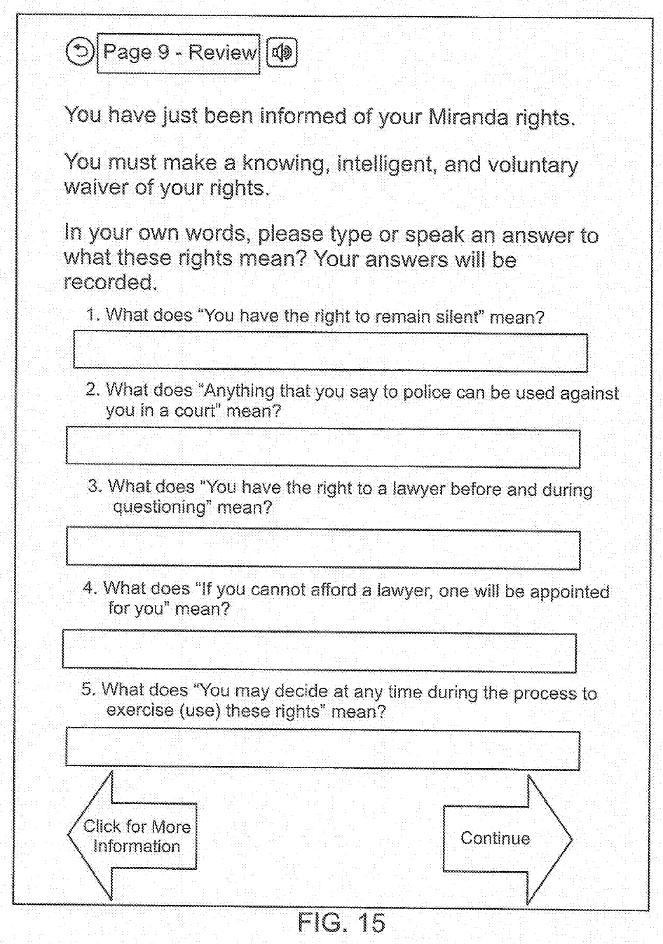

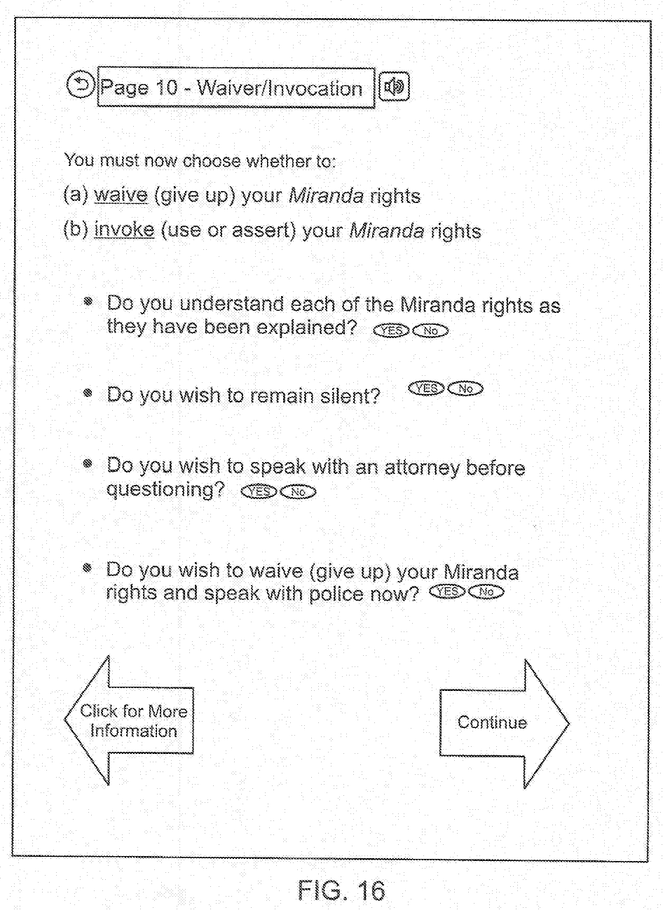

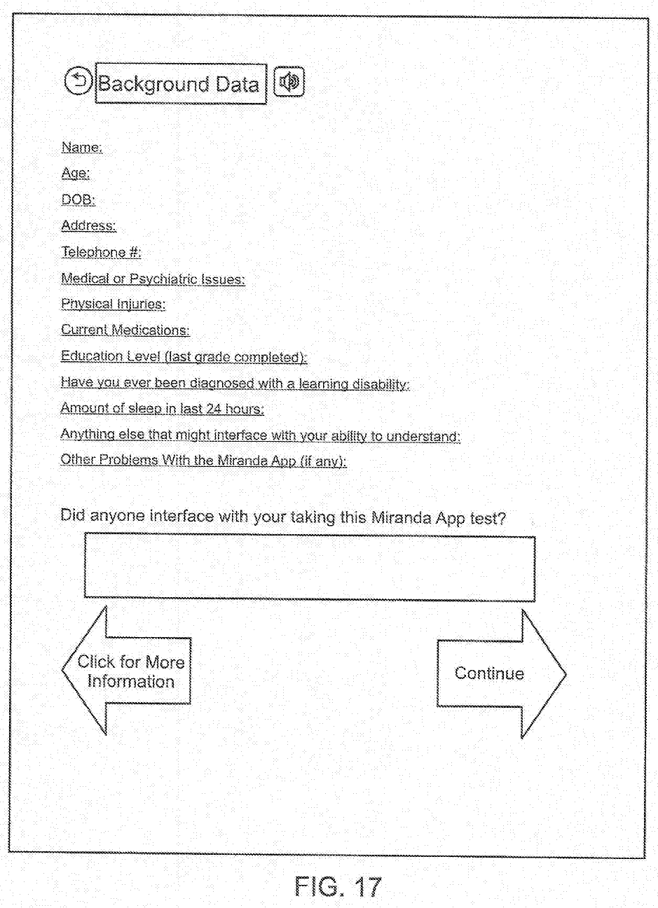

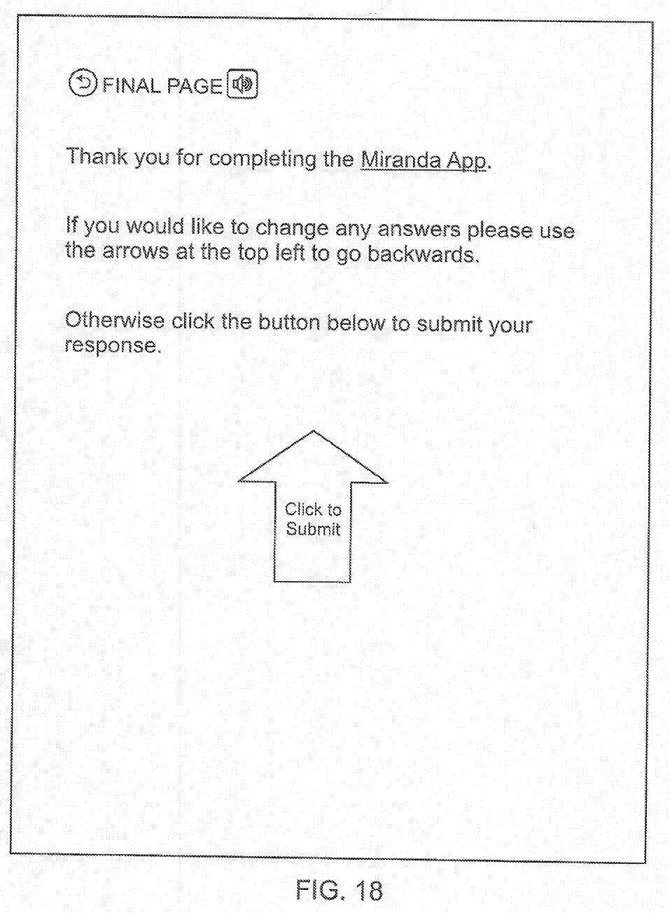

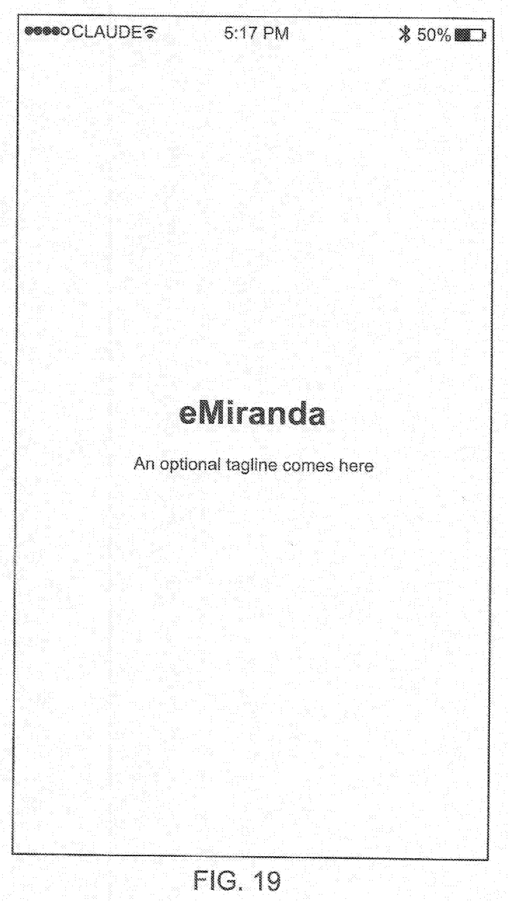

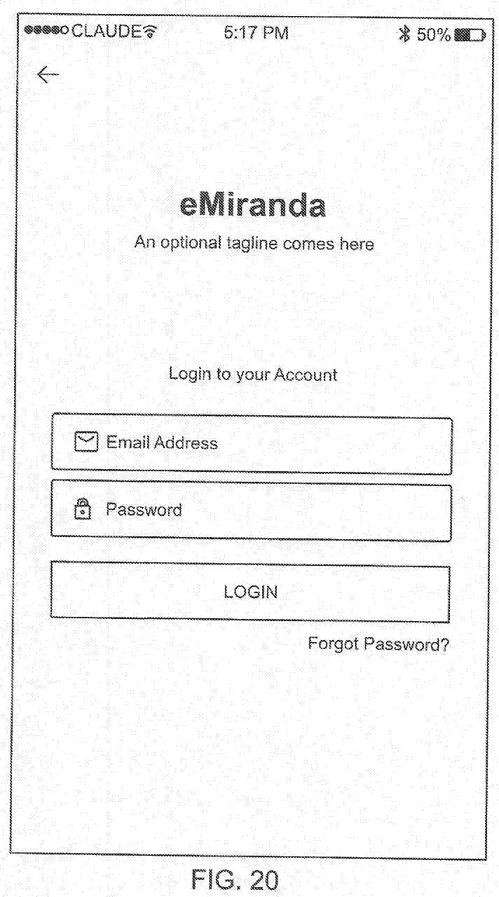

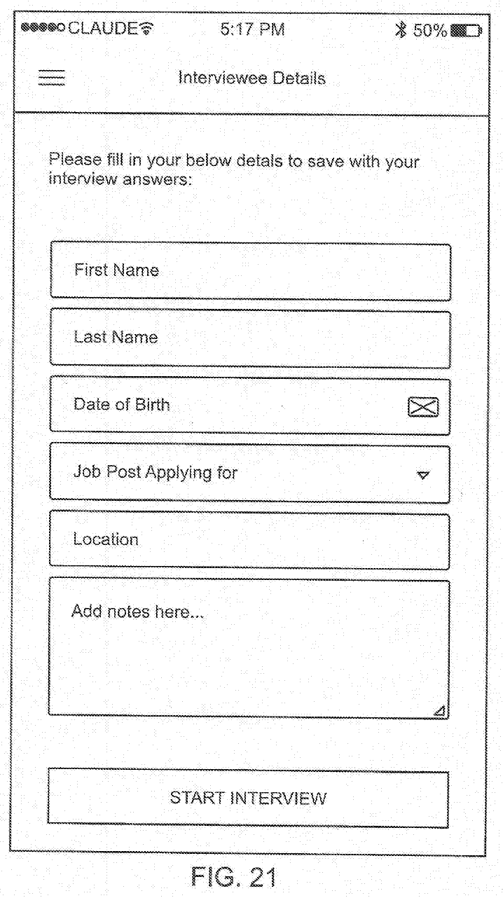

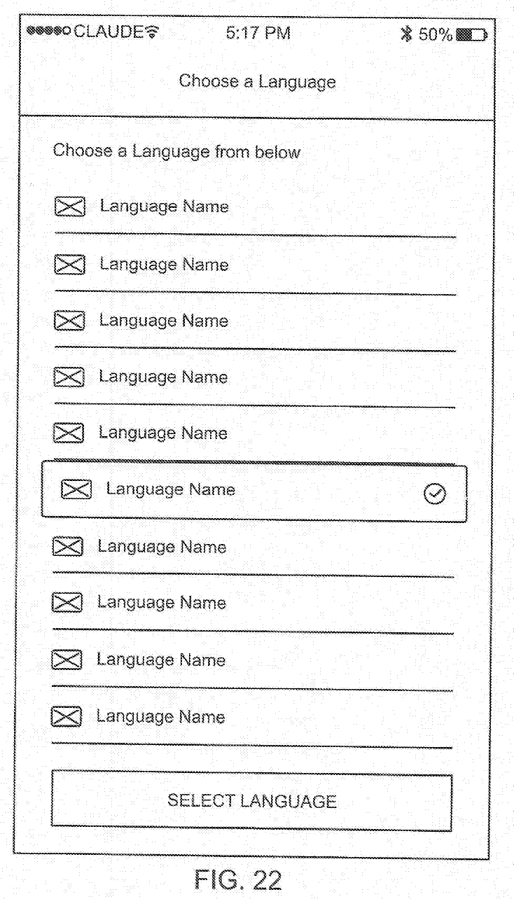

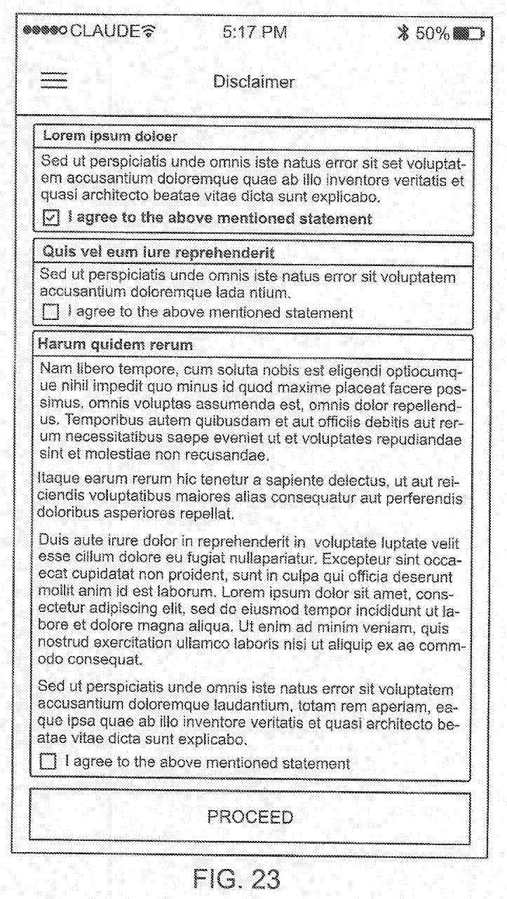

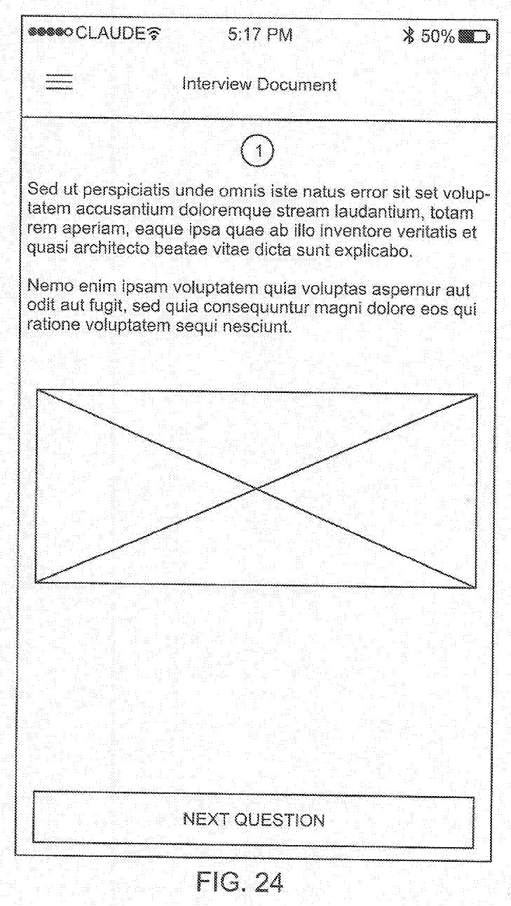

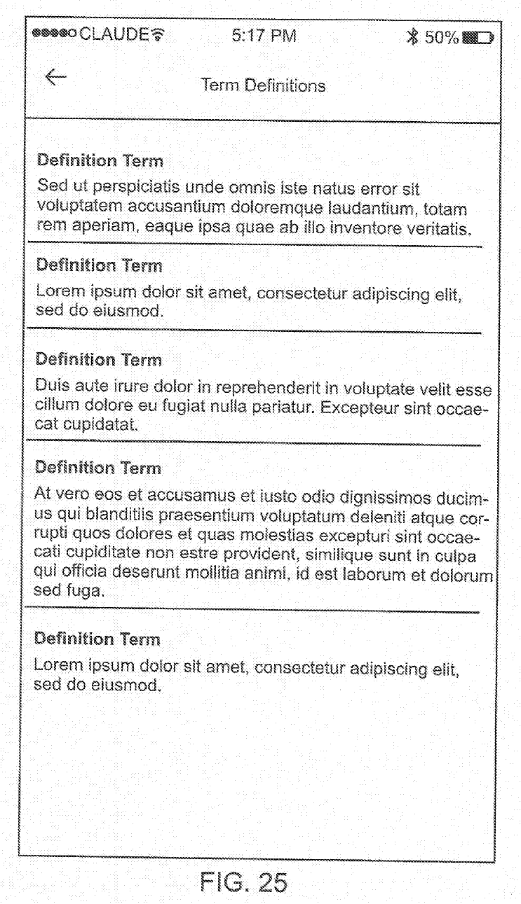

Referring first to the flow charts or FIG. 1, which outlined much of the problem; FIG. 2 which details initial efforts and FIG. 3-FIG. 5 which show outcomes embodied in FIGS. 6-26, the following are offered for consideration as examples, not limitations of the instant systems.

Administrator then uses the process to administer, to user, the MIRANDA warnings, whereby 5^{th} Amendment rights must be understood and acknowledged, and/or waived by USER, however the process is governed by AI logic and not human intervention of subjective inputs, said resultory Output being self-authentication eligible as evidence in Federal District Court or in the process of being so Certified.

Using digital means for improving administration of criminal justice goals, needs is proposed—the present inventor has combined artificial intelligence with a longstanding need to generate an application for computing devices embodying same.

Referring now to FIG. 6-26, screen shots and “wire frames” show step-by-step progression through the Digitai Miranda App as claimed and described.

Miranda Application Summary

Legal Safety Precautions—A.I. Preventive Measures
Live Audio and Video Recording of entire interaction with application user;
Checks and Balances System
   After each page where a question regarding a constitutional right is asked, the application user must verify his understanding of what is being asked of him.
   To do this, the user is asked “Do you understand______” and is prompted to check yes or no.
      If the user checks no, then they will be sent to a second page that will consist of the simplified explanation of the specific constitutional right they are having issue with.
      Further, if we are to assume that the user continues having issues understanding his right, this will be audio and video recorded for a third party to review and the user will be prompted to exit out of the application and handing the device the app is on back to the officer/detective/probation officer.

Wireframe 1:
User Login, Department Specific login that will be traceable to the poiice officer using the device the application is on.

Wireframe 2: (Audio and video recording begin here and will continue until the user exits out of the application);
Interview Details, basic information that could be found on a drivers' license.

Wireframe 3:
User will be prompted to select native language for the application to be carried out in:

Wireframe 4:
Disclaimer educating app user on what rights he has and what the miranda process is
   For more information regarding the disclaimer please see the Miranda App Summary attached in email.

Wireframe 5:
This is where the miranda process begins and the user will be prompted to check yes or no on his rights.
The user will be provided with cartoon like descriptions, the ability to read the words on the screen, and if needed for people suffering with hearing problems have the words read aloud.
If a user has any issues with any of the words (such as not understanding the word or sentence as a whole) they may click on any word that they have issue with and it will then take them to wireframe 6, where the word they clicked on will be highlighted with the definition proviced. Further, if they wanted they can spend more time on wireframe 6 getting a better understanding of the entire right as a whole, for example, “You have the right to remain silent” followed by the definitions provided in the Miranda App Summary.

Wireframe 6:
As noted above, this wireframe will serve as the definitions page where if anyone has any issues with a specific right or word, they may learn more about it to further develop a better understanding of their constitutional rights.

Note:
On wireframe 5 and 6 the user will have the ability to say that they do not understand their rights (by clicking on a link) and would rather have a human take over.

Wireframe 7:
Once the user has completed the Miranda app process, he/she will be asked one final time if they have a full understanding of their rights and if it was done in a non-coercive environment. This will require them clicking on a box without the aid of the police officer.
   Eventually when funds allow it, we would like to implement a face ID system that will be unique to the individual officer accounts. This in theory would allow us to know when the officers face is on the screen (which would mean he is in close enough proximity to possibly influence the user to selecting an answer he otherwise wouldn't have) and allow the app to issue a warning screen or some similar protective measure until the application is clear and only being used by the suspect who is being mirandized.
The final report of the Miranda readings will be sent back to the cloud with a copy of the audio/video mp3 file available for the courts (DA/PD, Attorney, Judge, Police, Etc.) to review it to determine whether or net the suspect was coerced during his Mirandizing.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or appiications for which the teachings of the present disclosure is/are used.

Those skilled in the art wiil recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”The phrase “and/or,” as used herein irt the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may bo combined in any suitable manner in one or more embodiments.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Reference throughout this specification to “one embodiment,” “an embodiment,” or similar language mans that a particular feature, structure, or characteristic described in connection with the embodiment is included in at least one embodiment of the present invention. Thus, appearances of the phrases “in one embodiment,” “in an embodiment,” and similar throughout this specification may, but do not necessarily, all refer to the same embodiment.

Furthermore, the described features, structures, or characteristics of the invention may be combined in any suitable manner in one or more embodiments In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the How chart diagrams, they are understood not to limit the scope of the corresponding method. Indeed, some arrows or other connectors may be used to indicate only the logical flow of the method. For instance, an arrow rnay indicate a waiting or monitoring period of unspecified duration between enumerated steps of the depicted method. Additionally, the order in which a particular method occurs may or may not strictly adhere to the order of the corresponding steps shown.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is mereiy intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments ofthe invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the Invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingiy, this invention includes all modifications and equivalents of the subject matter recited in the claims appended hereto as permitted by applicable law. Moreover, any combination of the above-described elements in all possible vanations thereof is encompassed by the invention uniess otherwise indicated herein or otherwise clearly contradicted by context.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the invention so claimed are inherently or expressly described and enabled herein.

As one skilled in the art would recognize as necessary or best-suited for performance of the methods of the invention, a computer system or machines of the invention include one or more processors (e.g., a central processing unit (CPU) a graphics processing unit (GPU) or both), a main memory and a static memory, which communicate with each other via a bus.

A processor may be provided by one or more processors including, for example, one or more of a single core or multi-core processor (e.g., AMD Phenom II X2, Intel Core Duo, AMD Phenom II X4, Intel Core i5, intel Core I & Extreme Edition 980X, or Intel Xeon E7-2820).

An I/O mechanism may include a video display unit (e.g., a liquid crystal display (LCD) or a cathode ray tube (CRT)), an alphanumeric input device (e.g., 3 keyboard), a cursor control device (e.g., a mouse), a disk drive unit, a signal generation device (e.g., a speaker), an accelerometer, a microphone, a cellular radio frequency antenna, and a network interface device (e.g., a network interface card (NIC), Wi-Fi card, cellular modem, data jack, Ethernet port, modem jack, HDMI port, mini-HDMI port, USB port), touchscreen (e.g., CRT, LCD, LED, AMOLED, Super AMOLED), pointing device, trackpad, light (e.g., LED), light/image projection device, or a combination thereof.

Memory according to the invention refers to a non-transitory memory which is provided by one or more tangible devices which preferably include one or more machine-readable medium on which is stored one or more sets of instructions (e.g., software) embodying any one or more of the methodologies or functions described herein. The software may also reside, completely or at least partially, within the main memory, processor, or both during execution thereof by a computer within system, the main memory and the processor also constituting machine-readable media. The software may further be transmitted or received over a network via the network interface device.

While the machine-readable medium can in an exemplary embodiment be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. Memory may be, for example, one or more of a hard disk drive, solid state drive (SSD), an optical disc, flash memory, zip disk, tape drive, “cloud” storage location, or a combination thereof. In certain embodiments, a device of the invention includes a tangible, non-transitory computer readable medium for memory. Exemplary devices for use as memory include semiconductor memory devices, (e.g., EPROM, EEPROM, solid state drive (SSD), and flash memory devices e.g., SD, micro SD, SDXC, SDIO, SDHC cards); magnetic disks, (e.g., internal hard disks or removable disks); and optical disks (e.g., CD and DVD disks).

Furthermore, numerous references have been made to patents and printed publications throughout this specification. Each of the above-cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

What is claimed is:

1. A system, further comprising at least a digital process to verify a user's understanding of a series questions comprising, in combination: MIRANDA rights and the implications of all warnings derived from the same, along with the user's rights under the Constitution of the United States of America in terms of rights to refuse to answer questions, which is able to be understood and interacted with by the user, while in custody, wherein all of the Miranda related information is presented in formats for both visual and auditory learners, and which is recorded live in both audio and video versions having electronic fail-safes to preclude alteration thereof, along with Artificial Intelligence powered by human mediated gates to preclude unmonitored self-learning from altering ostensively Justice-driven outcomes.

2. A system, further comprising at least a digital process to verify a user's understanding of a series questions comprising, in combination: MIRANDA rights and the implications of all warnings derived from the same, along with the user's rights under the Constitution of the United States of America in terms of rights to refuse to answer questions, which is able to be understood and interacted with by the user, while in custody, and is recorded live in both audio and video versions having electronic fail safes to preclude alteration thereof, and based solely upon legal precedent and facts ratified by an Administrator, wherein data sets remain proprietary and part of the system which re-introduces data sets into the system by Artificial Intelligence sorting and ranking.

3. The system of claim 1, stored in a non-transitory storage medium having power source access and appropriate hardware to function as a smartphone, tablet, headset and related interface between on-line, cloud and private server systems of data storage and management, which linkages are corraborable and the operations of which remain transparent and visible to the Administrator(s) designed for the system.

4. The system of claim 2, stored in a non-transitory storage medium having power source access and appropriate hardware to function as a smartphone, tablet, headset and related interface between on-line, cloud and private server systems of data storage and management, which linkages are corroborate and the operations of which remain transparent and visible to the Administrator(s) designed for the system.

5. A process for designing an artificially intelligent system with a legal dignity level enabling its products to be used in Courts of Law as evidence, which comprises, in combination, the steps of:
defining the process for administering MIRANDA warnings;
providing an electronically enabled digital (EEDD) device for delivering data to a user and/or participant;
engaging said EEDD with the user and/or participant in a topic neutral gender aschematic fashion whereby data only which is verified and ratified by an AI engine is applied to a fact pattern of legal data for MIRANDA warnings purposes including at a threshold level verification of identity—legal status, and language or symbol understanding;
confirming output generated is self-authenticatable in terms of compliance with the legal precedent and rights of user and/or participant under the Constitution of the United States and the Fifth Amendment, inter alia.

6. The process of claim 5, further comprising: a finishing step, which is a legal precedent update by an artificial intelligence module, programmed for this task.

7. The process of ciaim 6, products by of the same being a legal rule driven and justice-based output by designing the system to include the following steps:
perfecting a data set;
detailing future data collection needs;
employing technology drivers further comprising:
coding, defining app generation and testing;
completing BETA version operabie to run on tablets;
while offering end sharing with peers and scholarly authorities; and
releasing of the Miranda App.

8. Products by the process of claim 7, effective for and accepted to be deployed by a metropolitan police force in the United States.

9. A digital Miranda App, comprising, in combination:
Processes, implemented optionally on specialized portable electronic devices, wherein the Miranda related information is presented in formats for both visual and auditory learners;
the Miranda related information being offered for consideration, page by page for at least about a dozen screens, whereby key elements are set apart from the text for emphasis; and accompanied by cartoons or illustrations, each said at least about a dozen screens followed by a choice of one of two ending prompts indicating a need to touch one or the other—the choices being “click for more information” or “continue”;
a plurality of (hyper) linked explanation subroutines, connected to each said “click for more information” prompt, allowing a user to procure further data on any associated topic and then return to the place in the at least about a dozen screens from when each said “click for more information” prompt was actuated;
an Opt-out feature allowing users to r equest Officer/detainer administration of the Miranda related information;
a translation feature allowing a user to choose a native language, dialect or sign-language based subroutine; and the ongoing ability to repeat, review and return to any prior screen, until waiver or invocation of a user's rights under the Miranda related information is completed with a concomitant digital and/or hard copy record.

10. The digital Miranda App, as defined in claim 9, further comprising:
an explanation of the criminal procedure process, which must be chosen by prompt or by-passed by prompt, which further explains why MIRANDA warnings are required and what the goal of the digital Mirondo App is, namely to provide that information needed to allow one in custodial detention to make an intelligent and knowing choice whether to speak with the detainers/Police or not.

11. The digital Miranda App, as defined in claim 10, further comprising:
links to information regarding the enumerated topics of;
the MIRANDA CASE;
Police questioning;
Coercive environment;
constitutional rights; and
Custodial pressures;
each of which must be chosen by prompt or by passed by prompt.

12. The digital Miranda App, as defined in ciaim 11, further comprising:
iinks to information regarding the enumerated DEFINITIONS of;
Miranda;
Interrogation;
Coercive;
Stressful:
Constitutional rights;
Custodial pressure.

13. The digital Miranda App, as defined in claim 12, wherein the system is soft gated by events which a user can select for more information regarding a word, topic or constitution right by “clicking” or using a digitally displayed prompt to request more information.

14. The digital Miranda App, as defined in claim 13, wherein the system is hard gated by events which a user can elect to opt out of the system by “clicking” or using a prompt to request human intervention.

15. The digital Miranda App, as defined In claim 14, wherein the data stream is collected and utilized to make decisions as to whether a user knowingly and willingly waived constitutional rights, and remains part of a database without compromising any individual privacy rights.

16. An app. For smart devices effective to run on both APPLE® brand of—and SAMSUNG® brand of platforms, comprising, in combination:
graphic displays providing background information about which rights under the U.S. Constitution are triggered when one is subject of a custodial interrogation (the Miranda related information);
A series of button or prompts, which require the subject of a custodial interrogation to alternately confirm understanding of each topic and page, or request further data;
wherein all of the Miranda related information is presented in formats for both visual and auditory learners, and which is recorded live in both audio and video versions having electronic fail-safes to preclude alteration thereof, along with Artificial Intelligence powered by human mediated administration; and,
at least a resultory deliverable further comprising a digital signature/output/screen-shot producible in hard copy form/print-out or other record which has the requisite dignity level be to introduced as evidence in a Court of Law which shows that one subject to custodial interrogation has completed or opted out of the app. for smart devices effective to run on both APPLE® brand of—and SAMSUNG® brand of platforms.

17. The app. for smart devices effective to run on both APPLE® brand of—and SAMSUNG® brand of platforms, of claim 16, wherein the system is soft gated by events which a user can select for more information regarding a word, topic or constitution right by “clicking” or using a digitally displayed prompt to request more information.

18. The app. For smart devices effective to run on both APPLE® brand of—and SAMSUNG® brand of platforms of claim 17, wherein the system is hard gated by events which a user can elect to opt out of the system by “clicking” or using a prompt to request human intervention.

19. The app. For smart devices effective to run on both APPLE® brand of—and SAMSUNG® brand of platforms of claim 18, wherein the data stream is collected and utilized to make decisions as to whether a user knowingly and willingly waived constitutional rights, and remains part of a database without compromising any individual privacy rights.

20. Special purpose smart devices implementing the app. of claim 19 for use in the field.

21. At least a set of digitally corroborate processes, with Artificial Intelligence, to communicate and confirm communication of basic Constitutional Rights to a User in need of the same effective for universal adoption and ratification and/or approval by government bodies charged with administration of the same, whereby the rules of Law and fundamental fairness are preserved by application of facts of a case to the AI-updated rules of law.
